(19) United States
(12) Patent Application Publication
(10) Pub. No.: US 2018/0150042 A1
(43) Pub. Date: May 31, 2018

(54) FILL LEVEL MEASUREMENT DEVICE

(71) Applicant: VEGA GRIESHABER KG, Wolfach (DE)

(72) Inventors: Fridolin Faist, Oberwolfach (DE); Martin Wettlin, Schiltach (DE)

(73) Assignee: VEGA GRIESHABER KG, Wolfach (DE)

(21) Appl. No.: 15/881,354

(22) Filed: Jan. 26, 2018

Related U.S. Application Data
(62) Division of application No. 14/143,693, filed on Dec. 30, 2013.

(30) Foreign Application Priority Data
Jan. 8, 2013 (EP) 13 150 544.8

(51) Int. Cl. G05B 15/02; G05B 23/02

(52) U.S. Cl. CPC G05B 15/02; G05B 23/0216; G05B 2219/25428

(57) ABSTRACT

A fill level measurement device including a plurality of field devices each including a microprocessor and a sensor, wherein the microprocessor is configured to generate field device data of one of a plurality of subgroups of field device data based on communication with the sensor, wherein each field device data indicates points of time at which the field device data was generated, wherein each of the plurality of subgroups of field device data corresponds to one of a plurality of data types from a group comprising echo curves, DTM measurements, measurements, events detected by the field device, DTM files and documents.

This application claims the benefit of the filing date of EP Patent Application Serial No. 13 150 544.8 filed on 8 Jan. 2013, the disclosure of which is hereby incorporated herein by reference. This application is also a divisional of Application Serial No. 14/143,693, filed in the United States Patent and Trademark Office on Dec. 30, 2013, the entire contents of which are incorporated herein by reference.

### TECHNICAL FIELD

The invention relates to a fill level measurement device and a fill level measurement system in the area of industrial data acquisition. In addition, the invention relates monitoring and controlling field devices in the area of industrial data acquisition.

### TECHNICAL BACKGROUND

It is current practice in the field of pressure and fill-level measurement to use field devices which are fitted with microprocessors and which can collect and buffer diagnostic data and measurements in addition to the actual measurement task. The buffered data can then be read out and saved as files. The recorded files can subsequently be imported for analysis by analysis software, and some of the files visualized graphically. The known systems, however, are limited to managing measurement curves and require a large amount of time and effort to configure.

### SUMMARY OF THE INVENTION

A fill level measurement device including a plurality of field devices each including a microprocessor, and a sensor, is disclosed, wherein the microprocessor is configured to generate field device data of one of a plurality of subgroups of field device data based on communication with the sensor, wherein each field device data indicates points of time at which the field device data was generated, and wherein each of the plurality of subgroups of field device data corresponds to one of a plurality of data types from a group comprising echo curves, DTM measurements, measurements, events detected by the field device, DTM files and documents.

A method for monitoring and controlling field devices in the area of industrial data acquisition, i.e. the measurement of values, in the following also called “measuring value acquisition” is disclosed. A first step of the method is importing field device data comprising a plurality of subgroups of field device data. These subgroups of field device data can belong to different data types and may have been generated at different points in time. In addition, a single subgroup of field device data may have been generated at a plurality of points in time. For instance, a single subgroup may have been generated during a period of time. A second step of the method is determining the points in time at which the various subgroups of the imported field device data were generated. In a third step, each subgroup of the imported field device data is assigned to a respective field device. In a fourth step, a first group of the subgroups of the imported field device data is assigned to a first data type, and a second group of the subgroups of the imported field device data is assigned to a second data type. Finally, in a fifth step, the subgroups of the imported field device data are displayed graphically in a diagram as a function of the points in time at which they were generated and as a function of their data type. The steps of this method can be repeated in any way. In addition, importing the field device data can also take place in a plurality of steps.

Such a method provides an overview of a large amount of different field device data from one or more field devices. This saves time for a maintenance engineer, because a large amount of different field device data can be displayed simultaneously. The maintenance engineer can thus monitor a large amount of different field device data at once, and is thus able to monitor a large amount of field device data and/or numerous field devices in a given period of time. In addition, such a method can also be used to make it easier to monitor correlations between different groups of subgroups of field device data. For instance, it is possible to monitor whether a derived value is calculated from a measured value or whether there are gaps in the calculation of the derived value.

According to an embodiment of the invention, the method additionally comprises the step of selecting a subgroup of the imported field device data in the graphical display, and displaying graphically the field device data of the selected subgroup of the imported field device data.

In other words, it is possible in the overview of the subgroups of the imported field device data to select specifically a subgroup of the imported field device data, thereby displaying the corresponding data from the selected subgroup. Hence this enables a switch from the overview of the subgroups to a display of the data in the selected subgroup.

In a further embodiment of the method, the diagram comprises a coordinate system having a first axis and a second axis. The subgroups of the imported field device data are represented in the diagram by a symbol, wherein the symbol is positioned at a first coordinate on the first axis and at a second coordinate on the second axis. The first coordinate corresponds to the points in time at which the respective subgroup of the imported field device data was generated, and the second coordinate corresponds to the data type to which the subgroup of the imported field device data was assigned.

In other words, each of the subgroups of the imported field device data may be represented in the diagram by a respective symbol. For example, a first subgroup may be represented by a first symbol and a second subgroup may be represented by a second symbol.

The representation in a coordinate system makes it possible for a maintenance engineer to associate with each subgroup the respective point in time of data generation and its data type. This enables an overview of a large amount of field device data of different data types that have been recorded at different points in time.

In a further embodiment of the method, subgroups of the imported field device data that are determined over a period of time are represented by a bar. The bar extends along the first axis from a third coordinate to a fourth coordinate, wherein the third coordinate corresponds to the start of the generation of the subgroup of the imported field device data, and the fourth coordinate corresponds to the end of the generation of the subgroup of the imported field device data. The bar is positioned on the second axis at a fifth coordinate that corresponds to the data type of the subgroup of the imported field device data.

In other words, each of the subgroups of the imported field device data that are determined over a period of time may be represented in the diagram by a respective bar. For example, a first subgroup may be represented by a first bar and a second subgroup may be represented by a second bar.

It is thus possible to see the periods of time in which the respective subgroups of the imported field device data were generated. Hence gaps in a recording made over a period of time can be detected.

In a further embodiment of the invention, a measurement is represented in the coordinate system by a symbol that is positioned on the first axis at a sixth coordinate and on the second axis at a seventh coordinate. The sixth coordinate corresponds to the point in time at which the measurement was made, and the seventh coordinate corresponds to the value of the measurement.

Thus subgroups of imported field device data are displayed simultaneously with measurements in one graphical display as a function of the points in time of data generation. This provides a maintenance engineer with the functionality to monitor the generation of different subgroups of field device data simultaneously with the value of one or more measurements.

According to a further embodiment of the invention, the first group of subgroups of the imported field device data and the second group of subgroups of the imported field device data are assigned to a data type from the group comprising echo curves, DTM measurements, measurements, events detected by the field device, DTM files and documents. Here the abbreviation “DTM” stands for “Device Type Manager”. The echo-curve data type shows, for example, reflections of a radar signal as a function of the depth of a container. These are echo curves that have been recorded by a permanent connection to a control system and saved as a file. The DTM measurements are measurement curves that have been recorded by a permanent connection to a control system and saved as a file. The measurements are measurement curves that have been recorded automatically by the field device and read out later by a control system and saved as a file. The events detected by a field device are, for instance, status messages or changes to parameters that were recorded automatically by the field device and read out later by monitoring software and saved as a file. DTM files contain a copy of all the device parameter-settings that have been made, for example, by a VEGA DTM. The documents are any files as an attachment (images, drawings, reports etc.) that have been assigned to a selected field device.

According to a further embodiment of the invention, subgroups of the imported field device data from a field device are displayed in the diagram.

In a further embodiment of the invention, a first diagram containing subgroups of the imported field device data from a first field device, and a second diagram containing subgroups of the imported field device data from a second field device are simultaneously displayed graphically. In addition, three or more diagrams containing subgroups of the imported field device data from three or more field devices can be simultaneously displayed graphically.

This provides a maintenance engineer with the functionality to monitor different field devices simultaneously. The maintenance engineer can thereby see, for example, whether one of a plurality of field devices that are all performing a similar measurement is exhibiting a different behaviour from the other field devices.

In a further embodiment of the method, the field device data is imported in the form of files, and a data record is created for each file in a database.

In a further embodiment of the invention, for the purpose of displaying the field device data, the associated file is read out and the data stored in the file is displayed graphically.

According to an embodiment of the invention, the field device data is imported via a device interface, for example by means of an email or an SMS message.

The invention also relates to a control device for monitoring and controlling field devices in the area of industrial data acquisition, which control device is designed to perform a method described above and below.

In addition, the invention relates to a program element for monitoring and controlling field devices in the area of industrial data acquisition, which program element, when implemented in a processor of a control device, instructs the control device to perform a method described above and below.

Finally, the invention relates to a machine-readable medium on which is stored a program element for monitoring and controlling field devices in the area of industrial data acquisition, which medium, when implemented in a processor of a control device, instructs the control device to perform a method described above and below.

### SHORT DESCRIPTION OF THE FIGURES

FIG. 1 shows a diagram according to an embodiment of the invention, in which different groups of field device data are displayed.

FIGS. 2A, 2B and 2C show three diagrams according to an embodiment of the invention, in which different subgroups of field device data are displayed.

FIG. 3 shows a diagram according to an embodiment of the invention, in which a subgroup of field device data and measurements are displayed.

FIG. 4 shows a diagram containing an echo curve according to an embodiment of the invention.

FIG. 5 shows a control device for monitoring and controlling field devices in the area of industrial data acquisition, and four field devices and a machine-readable medium according to an embodiment of the invention.

FIG. 6 shows a flow chart of a method for monitoring and controlling field devices in the area of industrial data acquisition according to an embodiment of the invention.

The following description of the embodiments and the figures contains further features, advantages and possible applications of the invention. All the features that are described and/or depicted constitute in themselves and in any combination the subject matter of the invention, irrespective of how they are combined in the individual claims or dependency references. In the following description, where the same reference numbers are specified in different figures, then they refer to identical or similar elements. Identical or similar elements, however, can also be denoted by different reference numbers.

### DETAILED DESCRIPTION

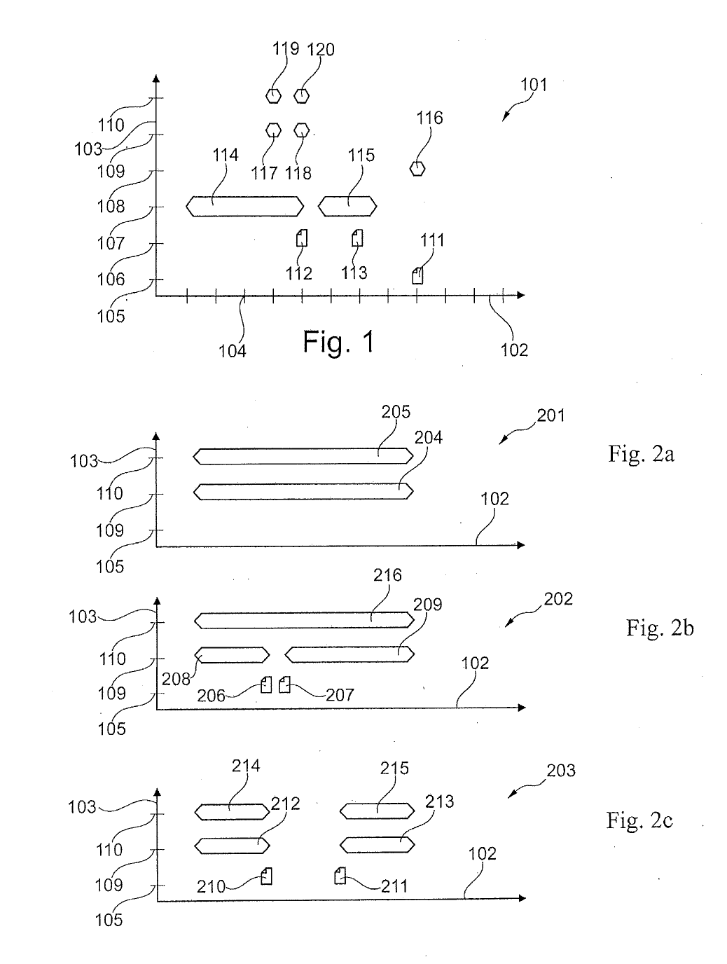

FIG. 1 shows a diagram having a coordinate system 101. The coordinate system 101 has a first, horizontal axis 102 and a second, vertical axis 103. The coordinates on the first axis 102 represent the points in time 104 at which the respective subgroup of the imported field device data was generated. The coordinates on the second axis 103 represent the data type to which the subgroup of the imported field device data was assigned. For example, the first coordinate 105 represents the documents data type, the second coordinate 106 represents the DTM-files data type, the third coordinate 107 represents the data type for events detected by the field device, the fourth coordinate 108 represents the measurements data type, the fifth coordinate 109 represents the DTM-measurements data type, and the sixth coordinate 110 represents the echo-curves data type. In the diagram, subgroups of field device data that have been assigned to the data type for DTM files and for documents are represented by a symbol 111, 112 and 113. In addition, the diagram shows that subgroups of field device data having the events data type were recorded by the field device in two different periods of time. This is represented by two bars 114 and 115. Subgroups of field device data having the measurements data type were recorded by the field device over a later period of time. This is represented by the bar 116. The recording during two different periods of time of subgroups of field device data having the DTM-measurements data type is represented by the bars 117 and 118. During the same two periods of time, subgroups of field device data having the echo-curves data type were likewise recorded. This is represented graphically by the bars 119 and 120.

Recordings of this type are typically used either generally for data-logging purposes or else for optimizing measuring systems or for fault analysis in problems installations.

The diagram 101 is, for example, part of a graphical calendar tool of a piece of monitoring software for easy access to the archive data from a field device. To improve orientation, the coordinate system can include construction lines and differently coloured areas. On the second axis 103, for instance, only precisely those data types are displayed for which field device data is stored. Thus it is possible to see at a glance whether, for example, subgroups of field device data having the echo-curves data type have been stored for the selected field device. A link is provided for each of the displayed graphical symbols. For example, clicking with the mouse on one of the symbols automatically switches to the appropriate view for the selected data type, and the time period that fits the selected symbol is preset automatically.

FIG. 2 shows a first diagram 201, a second diagram 202 and a third diagram 203. Each diagram has a coordinate system having a first axis 102 and a second axis 103. The coordinate on the first axis 102 represents the points in time at which the respective subgroup of field device data was generated. The coordinate on the second axis 103 represents the data type to which the group of the respective subgroups was assigned. In this embodiment, the data types for documents 105, DTM-measurements 109 and echo curves 110 are displayed on the second axis 103. In the first diagram 201, the bar 205 shows that subgroups of field device data having the echo-curves data type were recorded over a certain period of time. A second bar 204 shows that a subgroup of field device data having the DTM-measurements data type was recorded over the same period of time. For example, this subgroup may be a fill level derived from the echo curve. Thus it is evident from diagram 201 that a fill level was also being derived and recorded while an echo curve was recorded.

It is evident from diagram 202 that over the same period of time, a second field device has recorded a subgroup of field device data having the echo-curve data type. This is represented graphically by the bar 216. It can be seen from the bars 208 and 209, however, that a corresponding subgroup of field device data having the measurement data type, for instance a fill level, was not also being derived and/or recorded throughout the period of time in which an echo curve was recorded. This can indicate, for instance in the case of a derived fill level, that the measurement and/or recording of the echo curve was faulty during the period of this gap. This is logged, for example, in a file, which is represented by the symbol 206. The maintenance engineer can see from this graphical representation that the second field device has not recorded a measurement in a certain period of time. After rectifying this fault, the maintenance engineer logs this, for instance, in a further document, which is represented graphically by the symbol 207.

A third diagram shows graphically for a third field device that subgroups of field device data having the echo-curve data type were recorded in a first period of time and in a second period of time. Thus no subgroups of field device data having the echo-curve data type were recorded in a certain period of time. This is represented graphically by the bars 214 and 215. It can be seen from the bars 212 and 213 that a subgroup of field device data having the measurement data type, for instance a derived fill level, was also being recorded while subgroups of field device data having the echo-curve data type were recorded. This indicates to the maintenance engineer, for example, that at a certain period of time the recording of the echo curve by the field device was faulty, but the derivation of the fill level during the period of echo-curve recording was working. The field device logs, for example, the failure of the echo-curve recording in a document, which is represented graphically by the symbol 210. The maintenance engineer logs, for instance, that this fault has been rectified in a further document, which is represented by the symbol 211.

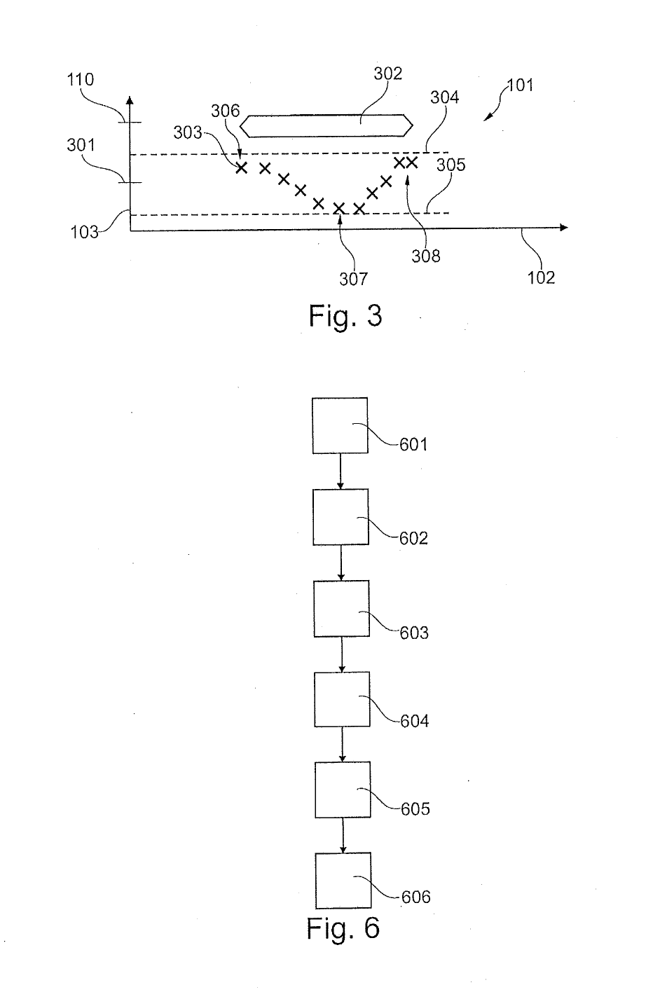

FIG. 3 shows a further diagram having a coordinate system 101. The coordinate system 101 has a first, horizontal axis 102 and a second, vertical axis 103. The coordinates on the first axis 102 represent the points in time 104 at which the respective subgroup of the imported field device data was generated. The coordinates on the second axis 103 represent the data type to which the subgroup of the imported field device data was assigned. In this embodiment, the coordinate 110 corresponds to the echo-curves data type and the coordinate 301 corresponds to the value of a measurement. For example, the measurement corresponds to a fill level derived from the echo curve. The dashed line 304 represents the upper maximum value of the measurement, for example of the fill level, and the dashed line 305 represents the lower minimum value of the measurement, for example of the fill level. Hence in the diagram, a symbol 302 is used to display simultaneously the period of time in which the echo curves were recorded and the value of the measurement, for example of a fill level. In this embodiment, it is evident that at the start of the recording, the fill level lay close to the upper maximum value (see reference number 303). At a later point in time, the fill level lay close to the lower minimum value (see reference number 307), and at the end of the recording, the fill level again lay close to the upper maximum value (reference number 308).

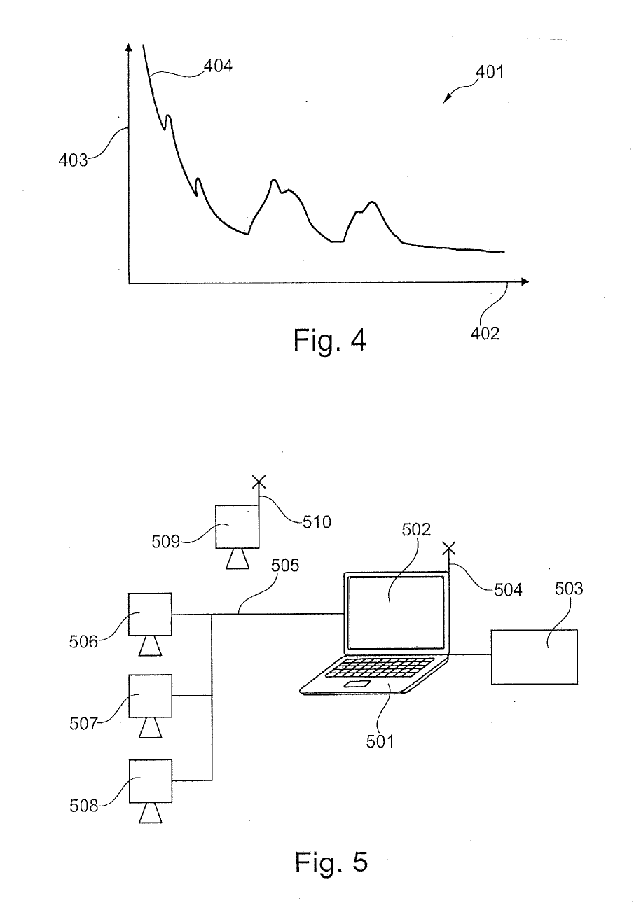

FIG. 4 shows a diagram 401, which is displayed graphically, for example, when a subgroup of the imported field device data is selected in the graphical display. In this embodiment, a subgroup that was assigned to the group of echo curves is selected. The echo curve is represented, for example, in a coordinate system having a first axis 402 and a second axis 403. The coordinate on the first axis 402 corresponds to a distance in metres. The coordinate on the second axis 403 corresponds to a signal strength in decibels. The echo curve 404 represents the strength of the reflection signal as a function of the distance.

FIG. 5 shows a control device for monitoring and controlling field devices, and for managing and visualizing field device data, in the area of industrial data acquisition. The control device contains a device 502 for graphical display, for example a screen, a machine-readable medium 503, for example a CD drive, and an antenna 504. A program element for monitoring and controlling field devices, for example, is stored on the machine-readable medium. In addition, the control device is connected via a line 505 to three field devices 506, 507, 508. A fourth field device 509 having an antenna 510 is connected to the control device via a radio link.

These field devices 506, 507, 508, 509 are equipped with microprocessors which can also collect and buffer diagnostic data and measurements in addition to the actual measurement task. Echo curves, fault statuses and changes to parameters, for example, can be buffered with time stamp as the diagnostic data. Measurements that have been made, electronic temperature or measurement reliability can be recorded as measurement curves. The buffered data can be read out later and saved as files when the user is connected to the field device by a piece of monitoring software.

In addition to the option of having the field device 506, 507, 508, 509 itself make these recordings, there is also the option to connect the field device permanently to a control device and for the control device to retrieve cyclically the required information and to save it as files. In addition, this setup can also be used to obtain a copy of all the parameter-setting data as a file.

Data that differs in terms of subject is typically saved as individual file types having a different file extension. The individual recording files can be imported into a control device 501 for subsequent analysis and some can be visualized graphically.

The control device 501 can not only be connected to field devices directly in order to read out the measurements and/or events and transfer these into a database but can also transfer the data as files from various machine-readable media 503 such as CDs or DVDs.

The measurement curves and events can be visualized after configuring a measurement view, as it is known.

A piece of monitoring software having a user interface, for example, is installed on the control device 501. Existing field device data can be transferred and assigned to existing data records, or new data records can be created to which the field device data is assigned. The monitoring software creates a separate data record for each field device 506, 507, 508, 509, which is identified by the serial number, for instance. In addition, there is the option to use the monitoring software directly to read out the measurement recordings and echo-curve recordings from the device interfaces of the field devices 506, 507, 508, 509.

In particular, in the monitoring software, the imported field device data can be assigned automatically to existing data records and incorporated into the calendar tool. The newly imported data can also be visualized directly from the calendar tool by means of the abovementioned symbols (e.g. bars). This does not require configuration.

In addition, various field devices 506, 507, 508, 509 having Internet access can send their data by email to a predefined email account. The monitoring software has functions for reading this email account and for transferring the measurement recordings contained therein. The user is provided with suitable functions for exporting 10 and importing the field device data as a facility for exchanging certain field device data between two control devices 501, each having one piece of monitoring software.

For subsequent access to the data, the monitoring software provides a field device list, which ensures unique access to field device data via a serial number. The monitoring 15 software provides a search and filter function for the field device list. The filter function searches, inter alia, for serial number, field device TAG and field device type. By means of specific input masks, the user can assign to the field devices 506, 507, 508, 509 a plurality of additional feature texts, which can also be included for the search and/or for the filtered display of the field device list.

As soon as the user has selected a field device 506, 507, 508, 509 from the field device list (for example by a single mouse-click on an entry in the field device list), a window (referred to below as the device data area) furnishes all the data available for the selected field device 506, 507, 508, 509. The device data area is arranged in tabs and 25 contains at least an “Information” tab and an “Available data” tab. The “Information” tab contains the essential identification data and user-selectable feature texts and/or images for the selected field device 506, 507, 508, 509. The “Available data” tab shows an overview of the full set of data on the selected field device 506, 507, 508, 509 in the form of a calendar tool or an overview calendar.

A further function of the monitoring software is the full-text search. As already mentioned, the system supports assigning any documents as an attachment. Using the full-text search function provides a method that searches the content of text-based documents (for example Word documents or PDF documents) for a search term, and displays the located hits in a selection list. Each entry in this list is provided with a link, so that by clicking with the mouse, the user can switch to the associated field device that has the document.

FIG. 6 shows a flow chart of a method for monitoring and controlling field devices in the area of industrial data acquisition. In a first step 601, field device data comprising a plurality of subgroups of field device data is imported. In a second step 602, points in time are determined at which the respective subgroups of the imported field device data were generated. In a third step 603, each of the subgroups of the imported field device data is assigned to a respective field device. In a fourth step 604, a first group of the subgroups of the imported field device data is assigned to a first data type, and in a fifth step 605, a second group of the subgroups of the imported field device data is assigned to a second data type. Finally, in a sixth step 606, the subgroups of the imported field device data are displayed graphically in a diagram as a function of the points in time at which they were generated and as a function of their data type.

In addition, it should be mentioned that the term “comprising” or “having” does not exclude any other elements or steps, and “a” or “an” does not rule out more than one. It should also be pointed out that features that have been described with reference to one of the above embodiments can also be used in combination with other features of other embodiments described above. Reference numbers in the claims shall not be deemed to have a limiting effect.

1. A fill level measurement device, comprising:
a plurality of field devices each including
a microprocessor, and
a sensor,
wherein the microprocessor is configured to generate field device data of one of a plurality of subgroups of field device data based on communication with the sensor,
wherein each field device data indicates points of time at which the field device data was generated, and
wherein each of the plurality of subgroups of field device data corresponds to one of a plurality of data types from a group comprising echo curves, DTM measurements, measurements, events detected by the field device, DTM files and documents.

2. The fill level measurement device according to the claim 1, wherein the microprocessor is further configured to control collection and buffering of diagnostic data corresponding to the respective field device.
